(19) United States
(12) Patent Application Publication
(10) Pub. No.: US 2019/0358786 A1
(43) Pub. Date: Nov. 28, 2019

(54) WRENCH WITH RAPIDLY ADJUSTABLE OPEN END

(71) Applicant: Hong Ann Tool Industries Co., Ltd., Taichung City (TW)

(72) Inventor: Cheng-Wei SU, Taichung City (TW)

(21) Appl. No.: 16/406,065

(22) Filed: May 8, 2019

(30) Foreign Application Priority Data
May 23, 2018 (TW) 107117542

(51) Int. Cl. B25B 13/22

(52) U.S. Cl. CPC B25B 13/22

(57) ABSTRACT

A wrench includes a first wrench body with a first jaw and a second wrench body with a second jaw movably coupled to the first wrench body and the first and the second jaws include a space therebetween. The first wrench has a first catching portion. The second wrench body defines a cavity and includes a locking device engaged in the cavity. The locking device includes a catch with a second catching portion disposed in the cavity and the second catching portion is selectively engagable with the first catching portion. The locking device includes a controller connected to the catch. The controller is operably movable to lever the catch. The locking device includes a resilient member urging the catch toward the first wrench body.

### BACKGROUND OF THE INVENTION

### 1. Field of the Invention

The present invention relates to a wrench and, particularly, to a wrench with rapidly adjustable open end.

### 2. Description of the Related Art

TW Patent No. 1613044 discloses a wrench with an adjustable open end delimited by a first jaw and a second jaw. The second jaw is movable with respect to the first jaw. The first and the second jaws respectively have a clamping surface for clamping a nut to be driven by the wrench. The second jaw includes a sleeve with a tooth surfaces sleeved thereon. The tooth surface defines the clamping surface of the second jaw. Further, the wrench includes a worm screw that is operably movable to control a relative position of the second jaw with respect to the first jaw.

The open end is unable to vary in size in a rapid manner because the worm screw engaged with a toothed rack and, for each 360° turn of the worm gear, the second jaw travels a distance corresponding to a pitch distance of the teeth of the rack.

The present invention is, therefore, intended to obviate or at least alleviate the problems encountered in the prior art.

### SUMMARY OF THE INVENTION

According to the present invention, a wrench with rapidly adjustable open end includes a first wrench body with a first jaw and a second wrench body with a second jaw movably coupled to the first wrench body and the first and the second jaws include a space therebetween defining the open end, which is configured to receive an object to be driven by the wrench.

The first wrench body has a shaft. The shaft has a first catching portion.

The second wrench body is movably coupled to the first wrench body. The second wrench body is movable on the shaft and defines a hole in which the shaft is inserted. The second wrench body defines a cavity and includes a locking device engaged in the cavity. The cavity is communicated with the hole. The locking device includes a catch with a second catching portion disposed in the cavity and the second catching portion is selectively engagable with the first catching portion. The catch is movable between a locked position in which the second catching portion is engaged with the first catching portion and thereby prevents the second wrench body from moving with respect to the first wrench body and an unlocked position in which the second catching portion is disengaged from the first catching portion and thereby allows the second wrench body to move on the shaft. The locking device includes a controller connected to the catch. The controller is operably movable to lever the catch. The controller has a lever portion and the catch is disposed on the lever portion. The cavity has an edge defining a fulcrum portion and the lever portion is pivotally disposed on the fulcrum portion. The controller has an input portion on which an effort force for levering the catch applies. A position of the lever portion that the fulcrum portion 331 supports is between the input portion 352 and the catch 34. The locking device includes a resilient member urging the catch toward the first wrench body to engage with the first catching portion and counteracting the effort force applied on the input portion.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a wrench in accordance with the present invention.

FIG. 2 is an exploded perspective view of an open end of the wrench of FIG. 1.

FIG. 3 is a plan view of the open end of the wrench of FIG. 1.

FIG. 4 is a cross-sectional view of the open end of the wrench of FIG. 1, with a locking device of the wrench in a locked position.

FIG. 5 is a cross-sectional view of the open end of the wrench of FIG. 1, with the locking device of the wrench in an unlocked position.

FIG. 6 is a cross-sectional view of the open end of the wrench of FIG. 1, with the locking device in the locked position, and with jaws disposed in a spaced relationship creating the open end.

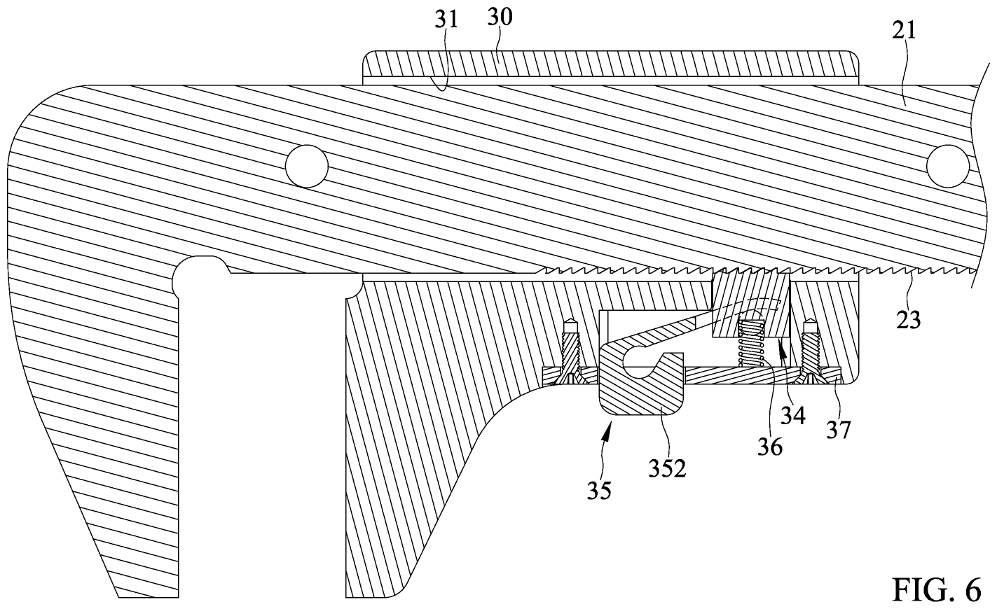

### DETAILED DESCRIPTION OF THE INVENTION

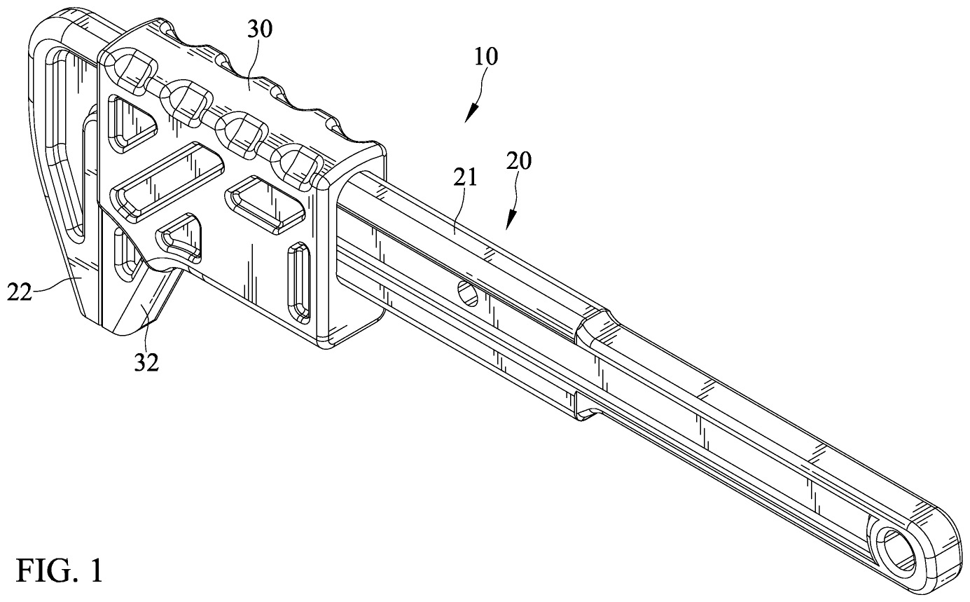

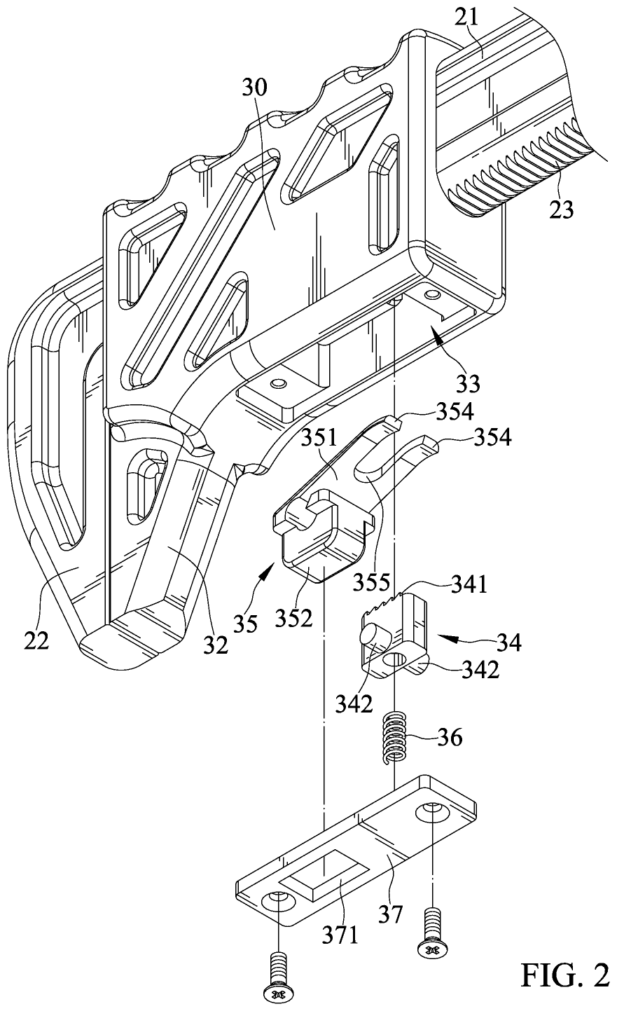

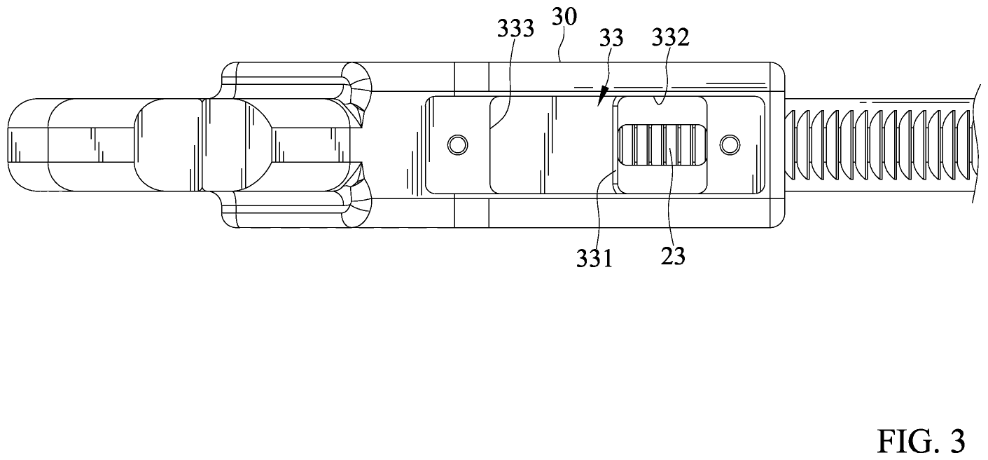

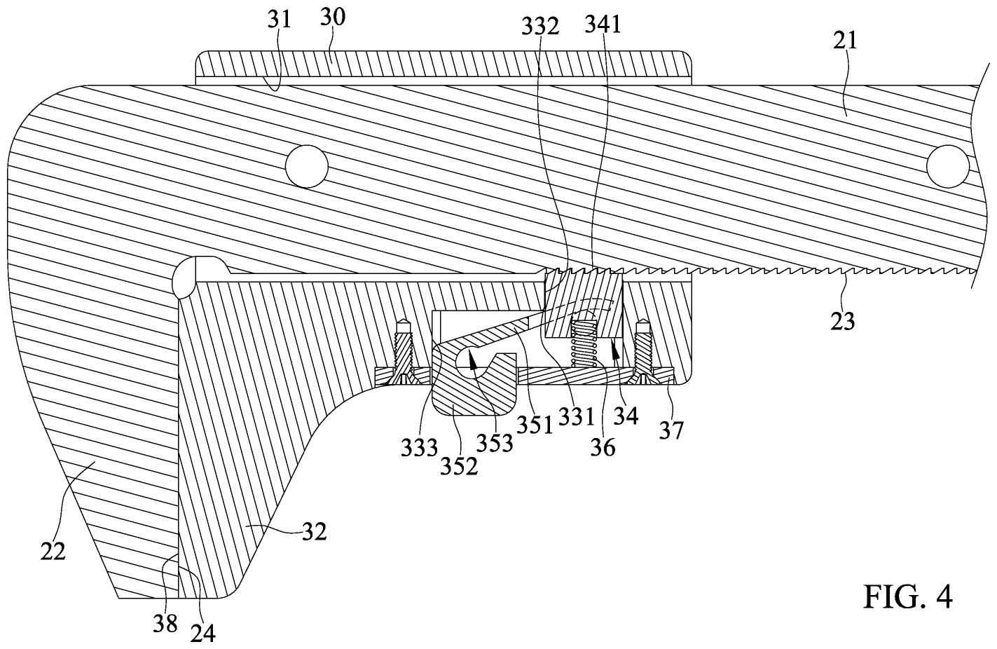

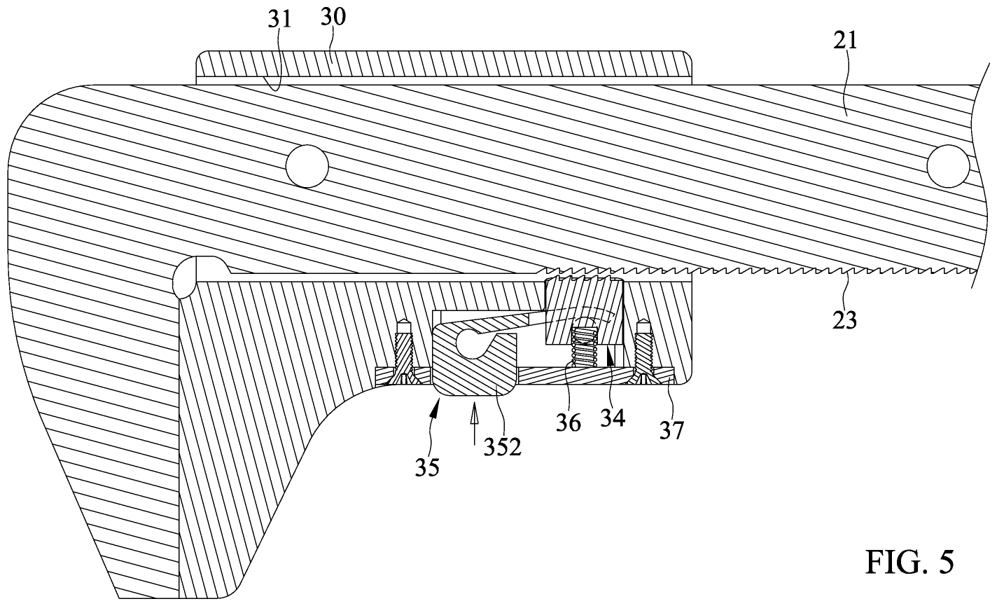

FIGS. 1 through 5 show a wrench 10 with a rapidly adjustable open end in accordance with the present invention.

The wrench 10 includes a wrench body 20 with a shaft 21 and a jaw 22. The shaft 21 has a catching portion 23. The catching portion 23 includes a plurality of teeth disposed one after another along a side of the shaft 21. The shaft 21 and the jaw 22 are made in one piece.

The wrench 10 includes a wrench body 30 with a jaw 32 movably coupled to the wrench body 20.

The jaw 32 and the jaw 22 include a space therebetween defining the open end which is configured to receive an object to be driven by the wrench 10. The jaw 22 and the jaw 32 are configured to cooperate to hold the object to be driven. Further, the object is disposed in the space delimited by the jaws 22 and 32. The jaw 22 and the jaw 32 are disposed oppositely with one another. The jaw 22 has a holding portion 24 and the jaw 32 has a holding portion 38 facing the holding portion 24. The object to be driven by the wrench 10 is held by the holding portion 24 and 38 of the jaws 22 and 32. In addition, when wrench 10 is disengaged from the object to be driven, the wrench body 30 can be moved to a position with respect to the wrench body 20 in which the holding portions 24 and 38 abut one another.

The wrench body 30 is movable on the shaft 21 and defines a hole 31 in which the shaft 21 is inserted. The wrench body 30 defines a cavity 33 and includes a locking device engaged in the cavity 33. The cavity 33 is communicated with the hole 31. The locking device includes a catch 34 with a catching portion 341 disposed in the cavity 33 and the catching portion 341 is selectively engagable with the catching portion 23. The catching portion 341 includes a plurality of teeth engagable with the plurality of teeth of the catching portion 23. The plurality of teeth of the catching portion 23 meshes with the plurality of teeth of the catching portion 341 when the catching portions 23 and 341 engage with one another. The catch 34 is movable between a locked position in which the catching portion 341 is engaged with the catching portion 23 and thereby prevents the wrench body 30 from moving with respect to the wrench body 20 and an unlocked position in which the catching portion 341 is disengaged from the catching portion 23 and thereby allows the wrench body 30 to move on the shaft 21. The catch 34 has a first side and a second side opposite to the first side and the first and the second sides each include a protrusion 342 protruding therefrom.

The locking device includes a controller 35 connected to the catch 34. The controller 35 is operably movable to lever the catch 34. The controller 35 has a lever portion 351 and the catch 34 is disposed on the lever portion 351. The cavity 33 has an edge defining a fulcrum portion 331 and the lever portion 351 is pivotally disposed on the fulcrum portion 331. The cavity 33 has a small cavity section and a large cavity section communicated with the small cavity section and a corner edge between walls of the small cavity portion 332 and the large cavity portion 333 is the edge that defines the fulcrum portion 331. In addition, the fulcrum portion 331 and the protrusions 342 abut opposite sides of the lever portion 351.

The lever portion 351 has a pronged end on which the catch 34 is disposed. The pronged end has two bearing portions 354 in a spaced relationship with one another such that the bearing portions 354 include a slot 355 disposed therebetween. The catch 34 is engaged in the slot 355 and includes the protrusions 342, which extend therefrom, abutting on the two bearing portions 354.

The controller 35 has an input portion 352 on which an effort force for levering the catch 34 applies. The input portion 352 is in a first position when the catch 34 is in the locked position. The input portion 352 is in a second position when the catch 34 is in the unlocked position. The input portion 352 in the first position is disposed away from the wrench body 20. The input portion 352 in the second position is disposed adjacent to the wrench body 20.

The controller 35 has a resilient portion 353 extending between the lever portion 351 and the input portion 352 such that the lever portion 351 is flexibly connected to the input portion 352. The input portion 352 and the catch 34 are on different ends of the lever portion 351. A position of the lever portion 351 that the fulcrum portion 331 supports is between the input portion 352 and the catch 34. The resilient portion 353 is in a released state when the input portion 352 is in the first position. The resilient portion 353 is in a tensioned state when the input portion 352 is in the second position. In addition, the lever portion 351, the resilient portion 353, and the input portion 352 are made in one piece.

The locking device includes a resilient member 36 urging the catch 34 toward the wrench body 20 to engage with the catching portion 23 and counteracting the effort force applied on the input portion 352. The resilient member 36 is a compression spring.

Further, a cover 37 is disposed on the wrench body 30 and extending over the cavity 33. The resilient member 36 is retained between the catch 34 and the cover 37. The resilient member 36 has one distal end abutting the catch 34 and another distal end abutting the cover 37. The cover 37 defines a through hole 371 and the input portion 352 is engaged in the through hole 371. The input portion 352 extends out of through hole 371 when the catch 34 is in the locked position.

In view of the foregoing, the controller 35 can be operated easily. Further, the controller 35 can lever the catch 34 from the locked position to the unlocked position rapidly. Moreover, when the catch 34 is in the unlocked position, the wrench body 30 can be moved to different positions with respect to the wrench body 20 rapidly and, thus, the open end of the wrench 10 can be adjusted rapidly.

The foregoing is merely illustrative of the principles of this invention and various modifications can be made by those skilled in the art without departing from the scope and spirit of the invention.

What is claimed is:

1. A wrench with rapidly adjustable open end comprising:
a first wrench body with a shaft and a first jaw, and wherein the shaft has a first catching portion; and
a second wrench body with a second jaw movably coupled to the first wrench body, wherein the second jaw and the first jaw include a space therebetween defining the open end which is configured to receive an object to be driven by the wrench, wherein the second wrench body is movable on the shaft and defines a hole in which the shaft is inserted, wherein the second wrench body defines a cavity and includes a locking device engaged in the cavity, wherein the cavity is communicated with the hole, wherein the locking device includes a catch with a second catching portion disposed in the cavity and the second catching portion is selectively engagable with the first catching portion, wherein the catch is movable between a locked position in which the second catching portion is engaged with the first catching portion and thereby prevents the second wrench body from moving with respect to the first wrench body and an unlocked position in which the second catching portion is disengaged from the first catching portion and thereby allows the second wrench body to move on the shaft, wherein the locking device includes a controller connected to the catch, wherein the controller is operably movable to lever the catch, wherein the controller has a lever portion and the catch is disposed on the lever portion, wherein the cavity has an edge defining a fulcrum portion and the lever portion is pivotally disposed on the fulcrum portion, wherein the controller has an input portion on which an effort force for levering the catch applies, wherein a position of the lever portion that the fulcrum portion supports is between the input portion and the catch, and wherein the locking device includes a resilient member urging the catch toward the first wrench body to engage with the first catching portion and counteracting the effort force applied on the input portion.

2. The wrench as claimed in claim 1, wherein the controller has a resilient portion extending between the lever portion and the input portion such that the lever portion is flexibly connected to the input portion, and wherein the lever portion, the resilient portion, and the input portion are made in one piece.

3. The wrench as claimed in claim 2, wherein the input portion is in a first position when the catch is in the locked position, wherein the input portion is in a second position when the catch is in the unlocked position, wherein the resilient portion is in a released state when the input portion is in the first position, and wherein the resilient portion is in a tensioned state when the input portion is in the second position.

4. The wrench as claimed in claim 3, wherein the input portion in the first position is disposed away from the first wrench body, and wherein the input portion in the second position is disposed adjacent to the first wrench body.

5. The wrench as claimed in claim 1, wherein the catch has a first side and a second side opposite to the first side and the first and the second sides each include a protrusion protruding therefrom, wherein the lever portion has a pronged end on which the catch is disposed, wherein the pronged end has two bearing portions in a spaced relationship with one another such that the bearing portions includes a slot disposed therebetween, and wherein the catch is engaged in the slot and includes the protrusions, which extend therefrom, abutting on the two bearing portions.

6. The wrench as claimed in claim 5, wherein the fulcrum portion and the protrusions abut opposite sides of the lever portion.

7. The wrench as claimed in claim 6, wherein the controller has a resilient portion extending between the lever portion and the input portion such that the lever portion is flexibly connected to the input portion, and wherein the lever portion, the resilient portion, and the input portion are made in one piece.

8. The wrench as claimed in claim 1 further comprising a cover disposed on the second wrench body and extending over the cavity, wherein the resilient member is retained between the catch and the cover, and wherein the cover defines a through hole and the input portion is engaged in the through hole.

9. The wrench as claimed in claim 8, wherein the input portion extends out of through hole when the catch is in the locked position.

10. The wrench as claimed in claim 9, wherein the controller has a resilient portion extending between the lever portion and the input portion such that the lever portion is flexibly connected to the input portion, and wherein the lever portion, the resilient portion, and the input portion are made in one piece.

11. The wrench as claimed in claim 9, wherein the catch has a first side and a second side opposite to the first side and the first and the second sides each include a protrusion protruding therefrom, wherein the lever portion has a pronged end on which the catch is disposed, wherein the pronged end has two bearing portions in a spaced relationship with one another such that the bearing portions include a slot disposed therebetween, and wherein the catch is engaged in the slot and includes the protrusions, which extend therefrom, abutting on the two bearing portions.

12. The wrench as claimed in claim 1, wherein the resilient member is a compression spring.

13. The wrench as claimed in claim 1, wherein the first catching portion includes a plurality of first teeth disposed one after another along a side of the shaft, wherein the second catching portion includes a plurality of second teeth engagable with the plurality of first teeth, and wherein the plurality of first teeth meshes with the plurality of second teeth when the first and the second catching portions engage with one another.

14. The wrench as claimed in claim 13, wherein the shaft and the first jaw are made in one piece.

15. The wrench as claimed in claim 1, wherein the cavity has a small cavity section and a large cavity section communicated with the small cavity section and a corner edge between walls of the small cavity portion and the large cavity portion is the edge that defines the fulcrum portion.
